(19) United States
(12) Patent Application Publication
(10) Pub. No.: US 2026/0003258 A1
(43) Pub. Date: Jan. 1, 2026

(54) METASURFACE OPTICAL ELEMENT, PROJECTION OPTICAL SYSTEM, IMAGE PROJECTION DEVICE, LIGHT SOURCE DEVICE, IMAGING DEVICE, AND OPTICAL SCANNING DEVICE

(71) Applicant: OPTOWL Co., Ltd., Hanamaki-shi (JP)

(72) Inventors: Osamu Nagase, Hanamaki-shi (JP); Yasuhiro Fujimura, Hanamaki-shi (JP); Hayato Yoshida, Hanamaki-shi (JP); Tomohiro Nakajima, Hanamaki-shi (JP)

(21) Appl. No.: 19/243,710

(22) Filed: Jun. 20, 2025

(30) Foreign Application Priority Data
Jun. 26, 2024 (JP) 2024-103141
May 12, 2025 (JP) 2025-080046

(51) Int. Cl. G03B 21/20; B82Y 20/00; G02B 1/00

(52) U.S. Cl. CPC G03B 21/2066; B82Y 20/00; G02B 1/002; G03B 21/208

(57) ABSTRACT

A metasurface optical element is a single optical element and includes a metasurface and a mirror surface. The metasurface includes a transmission surface that transmits light and on which a plurality of nanostructures are continuously arranged, the nanostructures being arranged with a density based on which a refractive index of the metasurface for the light is adjusted. The mirror surface has a flat plate shape and reflects the light that has passed through the metasurface. A dimension d of the nanostructures in a horizontal direction relative to the transmission surface and a wavelength λ of the light satisfy λ≥d. The optical element causes the light deflected by the metasurface to be reflected by the mirror surface so that the light is deflected in a direction different from an incident direction of the light.

### BACKGROUND OF THE INVENTION

### 1. Field of the Invention

The present invention relates to a metasurface optical element, and also to a projection optical system, an image projection device, a light source device, an imaging device, and an optical scanning device including the metasurface optical element.

### 2. Description of the Related Art

A metamaterial having fine sub-wavelength periodic structures is an artificial material that does not occur naturally. The metamaterial in a two-dimensional form is called a metasurface (see, for example, ACS Photonics 2024, 11 (3), 816-865, Publication Date: Feb. 27, 2024).

The intervals or sizes of fine periodic structures (metaatoms) included in the metasurface depend on wavelengths. Accordingly, in the field of relatively long wavelengths (radio frequency), applications such as intelligent reflection surfaces and beam scanning antennas are being developed extensively.

In recent years, the application of semiconductor processing technology has advanced techniques for finely processing glass and dielectrics, and optical elements having the metasurfaces have also been developed in the field of optics, where the wavelengths are short.

However, in the field of optics, the metasurfaces have been applied mainly to lenses, and applications to reflective optical elements, such as mirrors, have not been proposed.

In an ultra-short throw (UST) projector, in particular, a mirror surface is located rearmost in a projection optical system, and often has a relatively large area in the optical system to cover the entire area of an incident light beam.

High-functionality mirrors, such as a free-form correction mirror for achieving the desired performance on an image plane or a mirror with power, have also been developed, and an increase in the volume of a mirror itself has been a problem (see, for example, Japanese Patent No. 6993251 and Japanese Patent No. 6534802).

If an optical functional surface that is equivalent to such a complex-shaped mirror surface but has a flat plate shape can be obtained by using the metasurface technology, space can be greatly saved compared to an optical system including a folding mirror according to the related art having a concave surface.

In addition, it is known that when a concave mirror of the related art is reduced in thickness to reduce the size and weight, the heat capacity is also reduced, and therefore a temperature change may cause a change in the shape of a reflection surface. In a projector, the change in shape causes a phenomenon known as a temperature drift, which is a distortion (or defocusing) of the projected image. This is also a problem (see, for example, Japanese Patent No. 5280831 and Japanese Unexamined Patent Application Publication No. 2011-151640).

A metasurface mirror has a flat plate shape, and is therefore also expected to be effective in addressing the temperature drift.

### SUMMARY OF THE INVENTION

The present invention has been made to solve the above-described problems, and an object of the present invention is to provide a metasurface optical element having a mirror function to replace a curved surface with a flat surface in an optical system including a lens and a curved mirror, thereby saving space and suppressing a reduction in image quality due to a temperature change.

A metasurface optical element according to the present invention is a single optical element and includes a metasurface and a mirror surface. The metasurface includes a transmission surface that transmits light and on which a plurality of nanostructures are continuously arranged, the nanostructures being arranged with a density based on which a refractive index of the metasurface for the light is adjusted. The mirror surface has a flat plate shape and reflects the light that has passed through the metasurface. A dimension d of the nanostructures in a horizontal direction relative to the transmission surface and a wavelength λ of the light satisfy λ≥d. The optical element causes the light deflected by the metasurface to be reflected by the mirror surface so that the light is deflected in a direction different from an incident direction of the light.

According to the present invention, a metasurface optical element having a mirror function can be used to replace a curved surface with a flat surface in an optical system including a lens and a curved mirror, so that space can be saved. In addition, since an image formation position of light is determined by the diameter and pitch of pillars that serve as the nanostructures, a change in curvature due to expansion and contraction caused by temperature variations does not occur as in a curved mirror. Accordingly, even when the temperature varies, the image formation position is reliably maintained, and a reduction in image quality can be suppressed.

In addition, according to the metasurface, the focusing power for light incident on the meta-mirror and the direction in which the light is emitted can be individually designed by adjusting the distribution of the filling factor from the axis to the periphery of the meta-mirror. Therefore, for example, the meta-mirror may be designed to correspond to a curved mirror having a positive refractive power for causing each light-beam portion to focus light on an image plane, and a negative refractive power for increasing the field angle as a whole.

Thus, light can be projected or scanned over a wider field angle, so that the aperture size of the meta-mirror can be reduced. Thus, the number of meta-mirrors that can be obtained from a single wafer can be increased, and the cost can be reduced.

### BRIEF DESCRIPTION OF THE DRAWINGS

FIG. 1 is a schematic diagram illustrating the structure of a metasurface optical element according to a first embodiment of the present invention;

FIG. 2 is a schematic diagram illustrating an example of nanostructures on a surface of the metasurface optical element illustrated in FIG. 1;

FIG. 3 is a schematic diagram illustrating refraction by a convex lens;

FIGS. 4 is a schematic diagrams illustrating a variation in refractive index caused by the nanostructures illustrated in FIG. 2;

FIG. 5 illustrates an example of a metasurface;

FIGS. 6A to 6E illustrate an example of a method for producing the metasurface optical element;

FIG. 7 is a flowchart of the example of the method for producing the metasurface optical element;

FIGS. 8A to 8D illustrate another example of a method for producing the metasurface optical element;

FIG. 9 illustrates an example of the structure of the metasurface optical element produced by the method illustrated in FIGS. 8A to 8D;

FIG. 10 illustrates an example of the structure of an image projection device including a refracting-and-reflecting optical element according to the related art;

FIG. 11 illustrates an example of the structure of an image projection device including the metasurface optical element according to the present invention;

FIG. 12 illustrates another example of an image projection device including the metasurface optical element according to the present invention;

FIG. 13 illustrates an example of the structure of an optical device including the metasurface optical element according to the present invention;

FIG. 14 illustrates an example of the structure of an imaging device including the metasurface optical element according to the present invention;

FIG. 15 illustrates an example of the structure of an optical scanning device including the metasurface optical element according to the present invention;

FIG. 16 illustrates an example of the structure of the optical scanning device illustrated in FIG. 15 along a sub-scanning direction;

FIG. 17 illustrates an example of the structure of an optical path in the optical scanning device illustrated in FIG. 15;

FIG. 18 illustrates an example of the distribution of the filling factor in the metasurface optical element illustrated in FIG. 15;

FIG. 19 illustrates an example of the structure of the optical scanning device illustrated in FIG. 15 along the sub-scanning direction;

FIG. 20 illustrates an example of the structure of an optical scanning device including the metasurface optical element according to the present invention and a two-dimensional deflection mirror;

FIG. 21 illustrates an example of an operation of the optical scanning device illustrated in FIG. 20 in a main scanning direction;

FIG. 22 illustrates an example of the distribution of the filling factor in the metasurface optical element illustrated in FIG. 20; and

FIG. 23 illustrates an example of the structure of a magnifying projection device including the metasurface optical element illustrated in FIG. 22.

### DESCRIPTION OF THE PREFERRED EMBODIMENTS

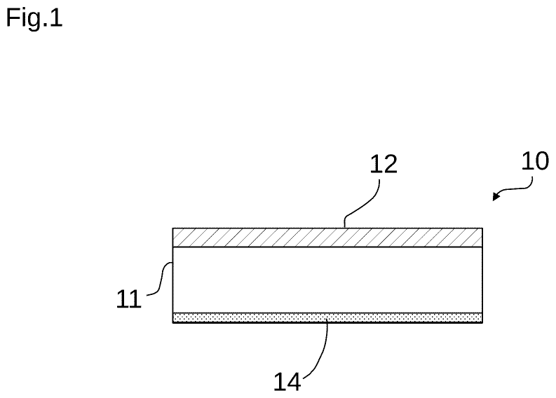

FIG. 1 illustrates an example of the structure of a metasurface optical element according to a first embodiment of the present invention.

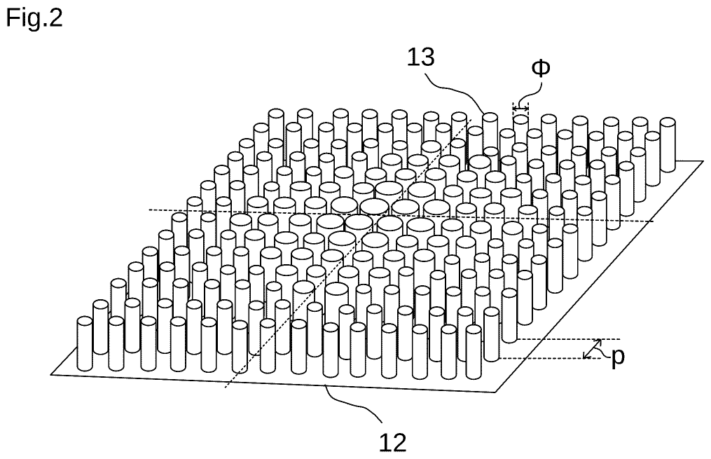

Referring to FIG. 1, a meta-mirror 10, which is an example of a metasurface optical element, is an optical element including a substrate portion 11 made of plate-shaped quartz glass. The substrate portion 11 has a transmission surface 12 that transmits light and on which a plurality of columnar pillars 13, which are nanostructures, are provided. A reflection surface 14A is provided at a side opposite to the side at which the transmission surface 12 is provided. Although the pillars 13 are columnar nanostructures with a diameter φ in FIG. 2, the structure of the pillars 13 is not limited to this and may be, for example, a polygonal prism with an upper surface that is polygonal, for example, triangular, quadrangular, or hexagonal, a shape obtained by combining rectangles, or a shape obtained by elongating these shapes in one direction.

In the present embodiment, the transmission surface 12, the pillars 13, and the substrate portion 11 are all made of quartz glass that transmits light. The reflection surface 14 is a mirror surface having a flat plate shape and formed of a metal plating or a metal plate with a surface that reflects light.

The transmission surface 12 serves as a metasurface when the intervals between the pillars 13 are less than the wavelength of transmitted light.

The transmitted light may have any wavelength. For example, in the present embodiment, light with a wavelength of λ=532 nm will be described as an example of light in the visible light range.

When the pillars 13 having the diameter φ are arranged adjacent to each other at intervals with a pitch p, the functionality of the transmission surface 12 as a metasurface varies in accordance with the filling factor of the pillars 13.

This is because when light waves enter the pillars 13 arranged at sub-wavelength intervals with the pitch p, the pillars 13 serve as metaatoms that hinder the light waves.

It is known that the overall refractive index of the transmission surface 12 can be changed from the refractive index of the material of the pillars 13 by changing the filling factor, that is, the density of the pillars 13.

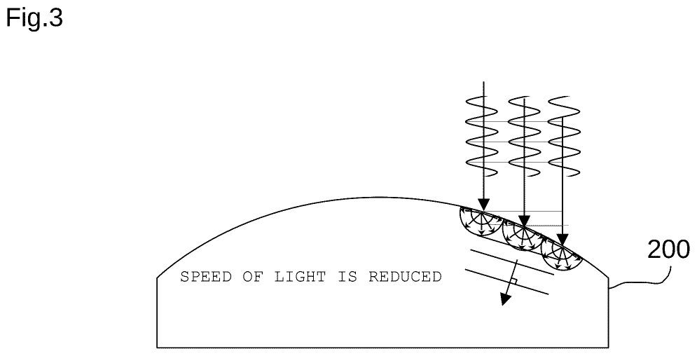

To describe this, as a simple example, FIG. 3 illustrates light waves that travel through a convex lens and phase wavefronts of the light waves.

In FIG. 3, the thin lines schematically show the phase wavefronts, which are parts of parallel light rays adjacent to each other having the same phase. Needless to say, the light travels in the direction normal to the phase wavefronts.

When the light enters the convex lens 200 having a refractive index n, the speed of the light is reduced in accordance with the refractive index, so that the phase wavefronts are tilted relative to the parallel light rays toward the convex direction of the convex lens 200. Since the direction in which the successive phase wavefronts travel is the travelling direction of the light, the travelling direction of the light is the tangential direction of the successive phase wavefronts, and is bent toward the direction of an optical axis of the convex lens 200, as illustrated in FIG. 3.

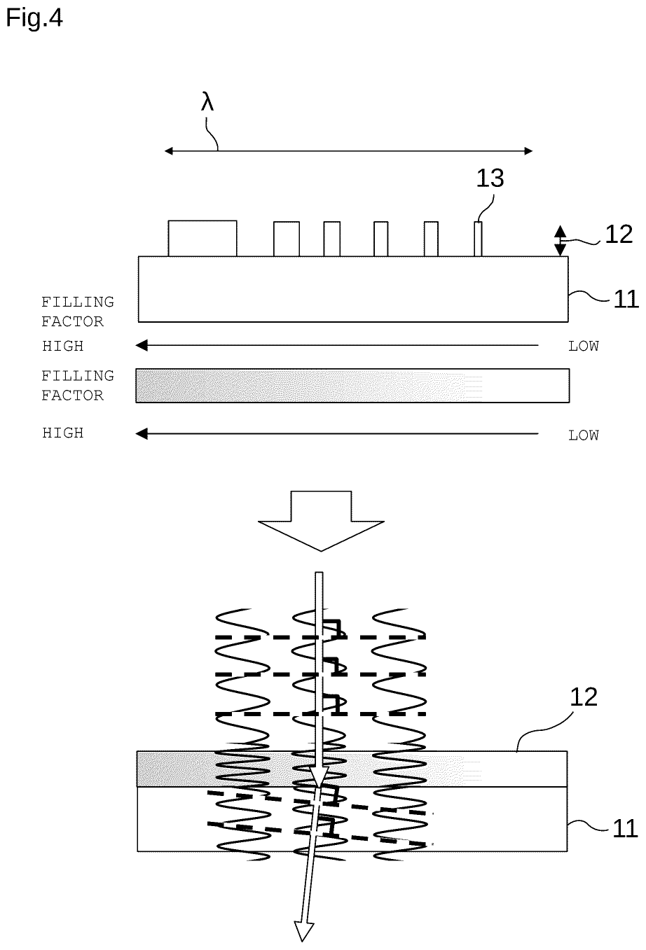

FIGS. 4 is a schematically illustrate the effects of the pillars 13 on the transmission surface 12, which is a metasurface. As illustrated in FIG. 4, when the pillars 13 smaller than the wavelength λ are arranged on the transmission surface 12, light with the wavelength λ does not recognize the pillars 13 on the transmission surface 12 as individual columns but as differences in the refractive index of the transmission surface 12 corresponding to differences in the filling factor.

In other words, the transmission surface 12, which is a metasurface, has a pseudo-refractive index n2 that varies in accordance with the diameters and heights of the pillars 13 and the intervals (pitch) of the pillars 13 that stand upright. The differences in the pseudo-refractive index n2 are roughly shown by the shades of gray in FIG. 4.

Therefore, as illustrated in FIG. 4, when parallel light rays are incident on the transmission surface 12 in a direction perpendicular to the transmission surface 12, the phase wavefronts of the incident light rays travel slower in regions with higher refractive indices, as illustrated in FIG. 4. As described above, the differences in the refractive index of the transmission surface 12 correspond to the differences in the filling factor of the pillars 13. In other words, for the transmitted light, a change in the filling factor of the pillars 13 in a certain region of the transmission surface 12 is equivalent to a change in an optical path length in that region.

Therefore, similarly to the refractive index of the convex lens 200 illustrated in FIG. 3, a delay equivalent to that of the phase wavefronts due to the difference in optical path length based on the lens thickness can be applied based on the refractive index of the transmission surface 12, so that a refraction effect similar to that of the convex lens 200 can be obtained.

Thus, when the pillars 13 are smaller than the wavelength λ of light, or sub-wavelength-sized, and when the refractive index of the transmission surface 12 has a gradient based on the filling factor as illustrated in FIG. 4, the wavefronts are delayed in accordance with the filling factor of the pillars 13, so that the phase wavefronts are tilted leftward as illustrated in FIG. 4.

When the sub-wavelength-sized pillars 13 are regularly arranged, this phenomenon serves a function similar to that of atoms for light waves travelling through molecular crystal lattices, causing the phase wavefronts to be distorted as if refracted.

Conversely, if such a distortion of the phase wavefronts can be artificially created by the regular arrangement of the pillars 13, the transmission surface 12 has an optical function equivalent to that of a lens surface having a refractive index n2.

This is the basic principle of an optical functional surface called a metasurface. The nanostructures, such as the pillars 13, on the optical functional surface are sometimes referred to as metaatoms by analogy with atoms.

It is known that, in practice, the condition for changing the phase wavefronts based on the above-described principle is to approximately satisfy Conditional Expression (1) given below, where λ is the wavelength of the transmitted light and φ is the diameter of the pillars 13. When, for example, the pillars 13 have a shape other than a columnar shape, the conditional expression may be λ≥d, where d is a dimension of the nanostructures in a horizontal direction relative to the transmission surface 12. When, for example, the pillars 13 are quadrangular prisms, d may be the length of the long side, short side, or diagonal. When the pillars 13 are triangular prisms, d may be the length of one side. In any case, the dimension d in the horizontal direction may be the length that is most typical in a geometrical sense when the pillars 13 are viewed in a vertical direction.

$$λ \geq φ \qquad ( 1 )$$

The development of this idea shows that, because the adjacent light waves are delayed, the degree of inclination of the convex lens can be reproduced in a simulated manner based on the amount of change in the density of the pillars 13 on the surface.

Thus, when the pillars 13 can be appropriately arranged along a surface in an optical element that satisfies Conditional Expression (1), the refractive index n2 in each region of the transmission surface 12 can be adjusted based on the density of the pillars 13, called metaatoms. When, for example, the refractive index n2 of the transmission surface 12 is concentrically distributed, refracted wavefronts similar to those obtained by the convex lens 200 can be obtained simply by causing light to pass through the transmission surface 12, which is flat.

As described above, the pseudo-refractive index n2 of the transmission surface 12 can be adjusted based on the density of the pillars 13, that is, the area occupied by the pillars 13 (filling factor) on a plane perpendicular to the transmitted light. In the present embodiment, the filling factor of the pillars 13 is changed by changing the diameter φ of the pillars 13 to adjust the density.

In other words, when the diameter of the pillars 13 can be distributed so that the phase wavefronts of light transmitted through the transmission surface 12 coincide with the phase wavefronts of light transmitted through a convex lens having the refractive index n2, light transmitted through the transmission surface 12 is similar to light transmitted through the convex lens having the refractive index n2.

This can be applied to create a functional surface with which light is transmitted through the transmission surface 12, reflected by the reflection surface 14, and transmitted through the transmission surface 12 to be emitted such that the phase wavefronts of the emitted light are similar to those of light emitted from a concave mirror with a free-form curved surface. Although a concave mirror is described herein, a convex mirror can be similarly reproduced by the flat transmission surface 12 and the reflection surface 14.

As described above, by appropriately changing the filling factor of the pillars 13 on the transmission surface 12 to control the phase wavefronts of light in each region of the transmission surface 12, the meta-mirror 10, which macroscopically has a flat plate shape, can have various functions of optical lenses in addition to the reflecting function provided by the reflection surface 14. This may be utilized to obtain a metasurface optical element that has a flat plate shape but provides the effects of a concave mirror or a convex mirror.

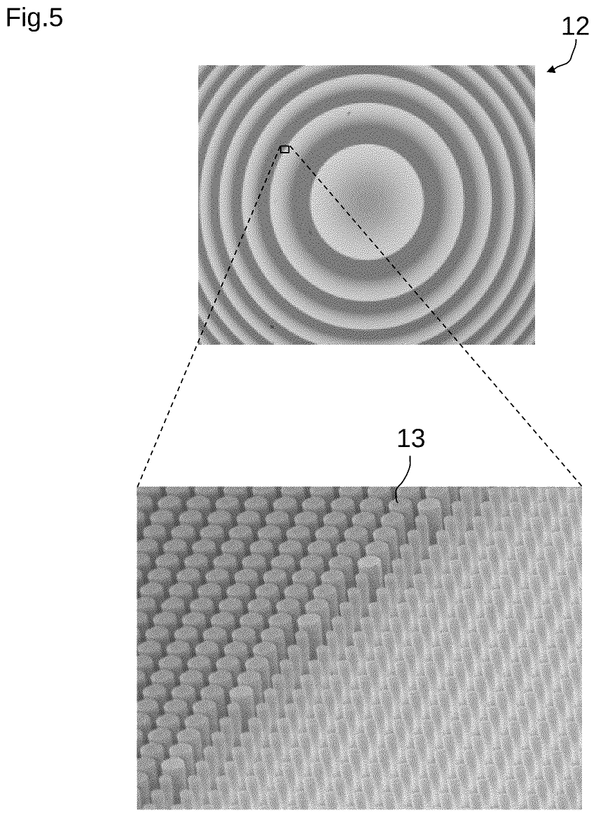

FIG. 5 illustrates an example of the transmission surface 12 of the meta-mirror 10 and an enlarged view of the pillars 13.

The pillars 13 formed on the transmission surface 12 of the present embodiment illustrated in FIG. 5 are sufficiently small relative to the wavelength of light to be transmitted.

The detailed design conditions and the manufacturing method are described in the documents of the related art, and thus are not described herein. However, when, for example, the filling factor is simply associated with numerical values into which the phase wavefronts of the incident light are converted using light-ray simulation software, the values are similar to those obtained by discretization of a lens surface, and the allowable density range increases.

In addition, the diameter of the pillars 13 formed on the meta-mirror 10 is generally limited. When the filling factor is adjusted based on the diameter of the columnar pillars 13, since the pillars 13 have a circular upper surface, the filling factor is about 78% at a maximum for a circle in a rectangle.

The pillars 13 are to be arranged such that the diameter of the pillars 13 is less than or equal to the wavelength at a maximum. Therefore, when the filling factor is determined based only on coefficients proportional to the numerical values of the phase wavefronts, the characteristics of the meta-mirror 10 as a metasurface cannot be sufficiently utilized. Therefore, the filling factor of the pillars 13 is to be within a certain range.

Accordingly, as a typical method for setting the filling factor to make the phase wavefronts equivalent to those in a refractive lens, the phase wavefronts may be converted into numerical values, and then the filling factor may be calculated as the remainder obtained by dividing each numerical value by 21.

When the phase wavefronts are converted into numerical values by the above-described calculation method, the filling factor varies with a period of 21. Therefore, as illustrated in FIG. 5, concentric bright and dark lines appear in accordance with the phase period. Therefore, when the transmission surface 12 is formed without using these methods, a meta-mirror 10 having no bright and dark regions as illustrated in FIG. 5 may also be obtained.

The method for producing the transmission surface 12 will now be described.

To produce nanostructures as those illustrated in FIG. 2, electron-beam lithography (EBL), for example, has been used in the related art. This method has a resolution of less than 10 nm, and is therefore widely used to produce metasurfaces. However, since this method is very slow and costly, a more efficient manufacturing method has been desired.

A known example of such a high-efficiency manufacturing method for large areas is a method of transferring patterns by nanoimprinting using an original mold 81 formed by lithography.

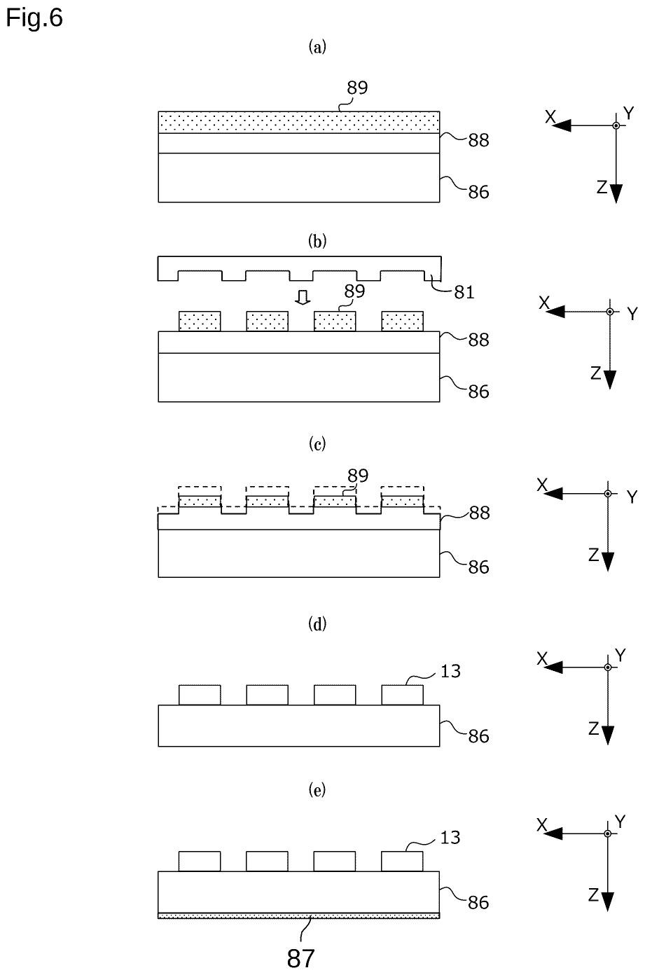

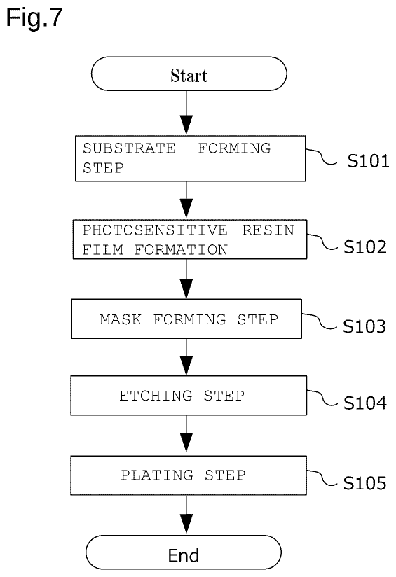

An example of a method for manufacturing an optical element including the meta-mirror 10 will be described with reference to FIGS. 6A to 6E and FIG. 7.

As illustrated in FIG. 6A, first, synthetic quartz glass 88 is formed on a quartz substrate 86, which serves as a material of the substrate portion 11 of the meta-mirror 10 (step S101 in FIG. 7). The reflection surface 14 may be formed in advance on a surface of the substrate 86 that is not to be processed. However, in the manufacturing method described herein, a reflective thin film is formed by, for example, vacuum deposition as the reflection surface 14 in the last step.

Next, a resist layer 89 made of a photosensitive resin is formed on the synthetic quartz glass 88 (step S102).

The original mold 81 is pressed against the resist layer 89 formed on the synthetic quartz glass 88. The original mold 81 has a pattern including columnar or prismatic voids formed in accordance with processing data for a shape that is an inversion of the pillars 13 to be formed. Thus, a layer including portions having the same shape as that of the pillars 13 is formed (step S103).

Step S103 described above is a mask forming step of forming a mask pattern in the resist layer 89. In the mask forming step, a pattern having the shape of the pillars 13 to be produced is formed in the resist layer 89 on the surface of the synthetic quartz glass 88.

The height of the pillars formed in the resist layer 89 in the mask forming step from the lower ends to the upper ends, in other words, the layer thickness of the resist layer 89, is preferably similar to the layer thickness of the synthetic quartz glass 88.

Although the mask is formed by nanoimprinting using the original mold 81 in the present embodiment, the mask may be formed by, for example, photolithography.

Next, dry etching, such as ECR plasma etching or RIE etching, is performed using etching gas obtained by mixing oxygen gas for etching the photosensitive resin and fluorocarbon-based gas for etching the synthetic quartz glass (step S104).

In step S104, which is the etching step, as illustrated in FIG. 6C, the resist layer 89 and the synthetic quartz glass 88 are etched such that the shape of the resist layer 89 is transferred to the synthetic quartz glass 88.

When etching is continued until the resist layer 89 is completely removed, the shape of the resist layer 89 is transferred to the synthetic quartz glass 88, so that the pillars 13 are formed as illustrated in FIG. 6D.

A manufacturing method similar to the above-described method may also be applied when, for example, the substrate 86 and the synthetic quartz glass 88 are made of the same material, or when the substrate includes a plurality of layers.

In the present embodiment, the resist layer 89 and the synthetic quartz glass 88 have similar layer thicknesses, and are etched at similar etching rates. Therefore, when the resist layer 89 is completely removed, the pillars 13 formed of the synthetic quartz glass 88 are separated from each other.

When the substrate 86 is made of a material that is not etched or not easily etched by the etching gas, the pillars 13 are similarly formed even if the resist layer 89 and the synthetic quartz glass 88 have different layer thicknesses.

Similarly, the mixing ratio of the etching gas or the materials of the substrate 86 and the synthetic quartz glass 88 may be changed to adjust the etching rates in accordance with the layer thicknesses.

As illustrated in FIG. 6E, after the pillars 13 are formed on the transmission surface 12, a metal reflective layer 87 is formed on a surface at a side opposite to the side at which the pillars 13 are formed (step S105). When viewed from the transmission surface 12, the metal reflective layer 87 defines the reflection surface 14. As described above, a member in which the metal reflective layer 87 is formed in advance on the substrate 86 as a mirror may also be used. Although the metal reflective layer 87 is formed by a thin-film forming method, such as vapor deposition, other methods for forming a metal layer may be used.

The metal reflective layer 87 may be, for example, a metal thin film made of aluminum, silver, or the like or a dielectric multilayer film.

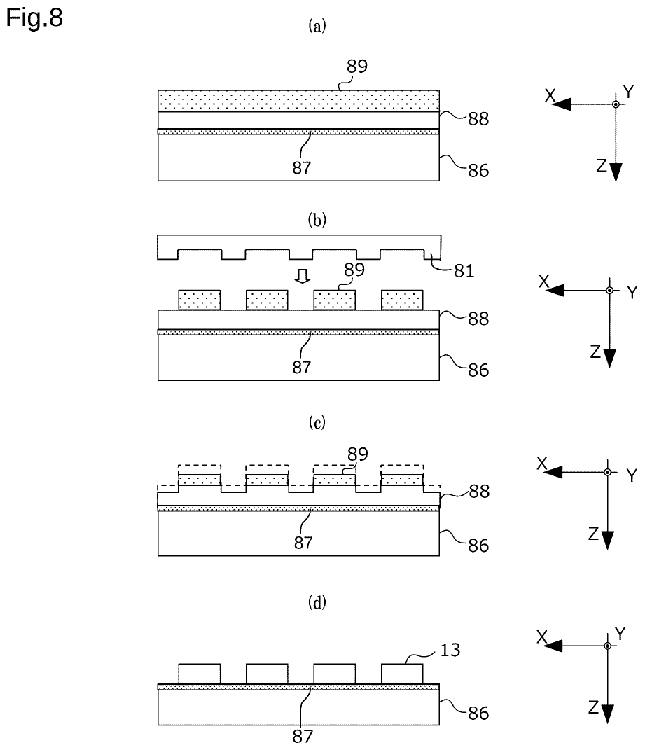

As another example, as illustrated in FIGS. 8A to 8D, the metal reflective layer 87 may be provided between the upper surface of the substrate 86 and the synthetic quartz glass 88. In such a case, in the etching step denoted by S104 in FIG. 7, the metal reflective layer 87 serves as an etching end layer, as illustrated in FIG. 8D.

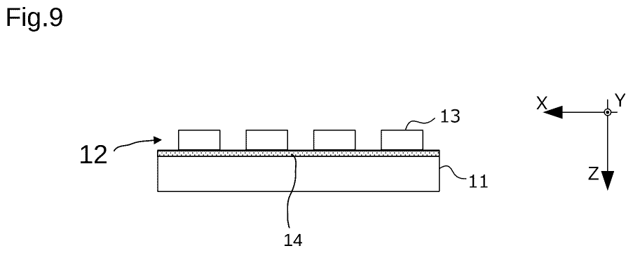

According to this manufacturing method, the meta-mirror 10 has a multilayer structure in which the reflection surface 14 is positioned between the transmission surface 12 and the substrate portion 11, as illustrated in FIG. 9. Also in this case, the pillars 13 serve as metaatoms and have a refraction effect. Thus, the meta-mirror 10 can be manufactured without a large difference in the function of the meta-mirror 10.

Some examples of use of the meta-mirror 10 manufactured as described above will now be described.

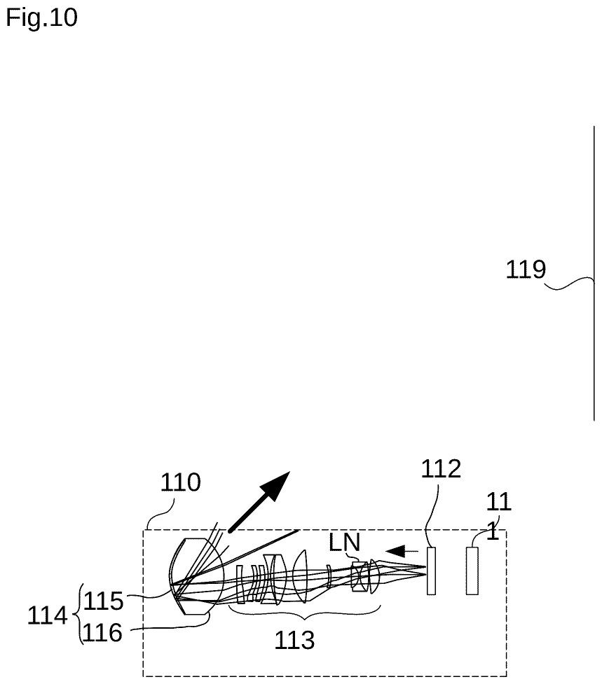

Referring to FIG. 10, an image projection device 110 will be described as the most typical example of the related art. The image projection device 110 projects an image toward a screen 119, which serves as a projection surface.

The image projection device 110 includes a light source 111, an image display element 112 for displaying image information to be projected onto the screen 119, a refracting optical system 113 including a plurality of lenses LN, and a refracting-and-reflecting optical element 114 disposed rearmost relative to the refracting optical system 113.

The refracting-and-reflecting optical element 114 includes a reflection surface member 115 and a refractive medium 116. The reflection surface member 115 includes a reflection surface, and the refractive medium 116 is in close contact with the reflection surface. The reflection surface member 115 and the refractive medium 116 are integrated together to serve as a “single optical element”.

According to the above-described structure of the related art, light is refracted by the refractive medium 116 and reflected by the reflection surface member 115 in the refracting-and-reflecting optical element 114. Therefore, the distance between the image projection device 110 and the screen 119 can be reduced, and the controllability of the light rays can be improved so that the desired optical design values can be easily obtained.

As is clear from FIG. 10, to obtain the desired optical design values, the refracting-and-reflecting optical element 114 included in the above-described structure tends to have a large volume. This may make it difficult to reduce the size of the structure.

The reflection surface member 115 is large, and is therefore desired to be as thin as possible. In addition, the reflection surface member 115 is often made of a resin or the like to reduce the weight. However, when the thickness and weight of the reflection surface member 115 are simply reduced, the heat capacity of the reflection surface member 115 is naturally reduced. Therefore, when, in particular, the light source 111 is a high-brightness light source, or depending on the temperature of the operating environment, the influence of distortion of the reflection surface member 115 due to heat may be non-negligible. When the reflection surface member 115 has a free-form curved surface, the distortion tends to cause an anisotropic expansion, which greatly affects the image quality of the image projection device 110.

In general, a known method for reducing the influence of temperature variations on the aberration performance, for example, involves a design in which materials having different temperature characteristics are combined to cancel the changes in characteristics caused by temperature variations. However, combining different materials means that the range of materials that can be used is limited. It has been difficult to select optical materials capable of reducing the influence of temperature variations on the characteristics and increasing the range of operating environment temperatures.

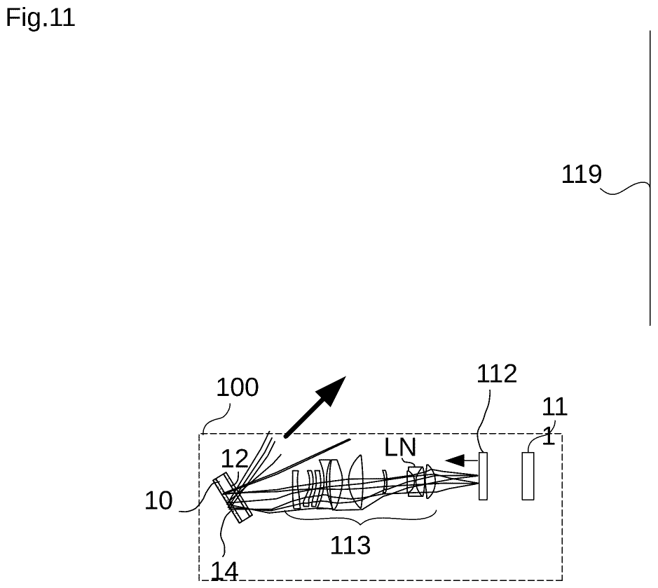

Accordingly, in an image projection device 100 illustrated in FIG. 11, the refracting-and-reflecting optical element 114 is replaced by a meta-mirror 10 having a metasurface.

In the structure illustrated in FIG. 11, a light source 111, an image display element 112 for displaying image information to be projected onto a screen 119, and a refracting optical system 113 including a plurality of lenses LN are the same as those in the image projection device 110. Therefore, these components are denoted by the same reference signs as those in the image projection device 110, and description thereof is omitted.

In the present embodiment, the refracting-and-reflecting optical element 114 is replaced by the meta-mirror 10 having the same function.

As illustrated in FIGS. 1, 2, and 9, the meta-mirror 10 in the above-described structure includes, as the transmission surface 12 that transmits light, a metasurface on which the plurality of pillars 13 are continuously arranged with a density based on which a refractive index for the light is adjusted. The meta-mirror 10 also includes the reflection surface 14 that is a mirror surface having a flat plate shape and that reflects the light that has passed through the transmission surface 12. The transmission surface 12 and the reflection surface 14 are included in a single optical element.

As illustrated in FIG. 11, the meta-mirror 10 deflects the light in a direction different from an incident direction by causing the reflection surface 14 to reflect the light deflected by the transmission surface 12.

The filling factor of the pillars 13 formed on the transmission surface 12 of the meta-mirror 10 is set to adjust the phase wavefronts so as to reproduce the lens shape of the refractive medium 116 of the refracting-and-reflecting optical element 114 illustrated in FIG. 10.

The distribution of the filling factor for causing the phase wavefronts of the light emitted from the meta-mirror 10 to coincide with the phase wavefronts of the light emitted from the refracting-and-reflecting optical element 114 can be obtained by, for example, light ray simulation.

As illustrated in FIG. 11, the size of the optical element can be reduced by using the meta-mirror 10 with which the refracting-and-reflecting optical element 114 is reproduced.

When the existing refracting-and-reflecting optical element 114 is replaced by the meta-mirror 10, the size and weight of a folding mirror optical system can be further reduced by using the optical element having a flat plate shape and having both refractive and reflective properties.

In addition, in the present embodiment, the pillars 13 and the substrate portion 11 are both made of quartz glass, and have no difference in the coefficient of thermal expansion. Also, unlike the refracting-and-reflecting optical element 114, the meta-mirror 10 has a refractive power determined by the filling factor of the pillars 13. Since the meta-mirror 10 is an optical element having a flat plate shape, the meta-mirror 10 is likely to expand isotropically when thermal expansion occurs.

In other words, even when thermal expansion occurs due to the high-brightness light source 111 or other heat sources, unlike the reflection surface member 115 having a free-form curved surface, the entire structure of the meta-mirror 10 expands and contracts uniformly, so that the relationship between the filling properties of the metaatoms, which affects the reflected wavefronts, does not change.

For the above-described reason, when the meta-mirror 10 is used, the influence of heat can be reduced compared to when the refracting-and-reflecting optical element 114, which is an optical element having a strong refractive power and a free-form curved surface, is used.

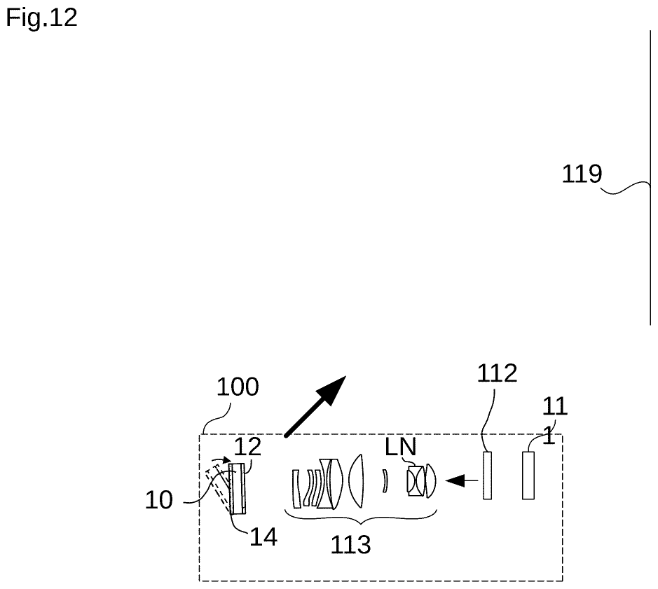

In addition, according to the meta-mirror 10, the direction in which the light rays are reflected can be adjusted to any direction by adjusting the filling factor. More specifically, although the meta-mirror 10 is placed such that the reflection surface 14 is inclined relative to the direction in which the light beam from the refracting optical system 113 is incident in FIG. 11, the filling factor may be further adjusted to define the reflection direction as illustrated in FIG. 12. In this case, the length of the housing of the image projection device 100 can be reduced, so that the size and weight can be further reduced.

In FIG. 12, the meta-mirror 10 is placed upright in a direction perpendicular to an optical axis of the lenses LN of the refracting optical system 113. This structure enables reduction of the dead space in the entire image projection device 100, so that the size and weight can be further reduced.

The above-described structure of the meta-mirror 10 is also applicable to other optical devices.

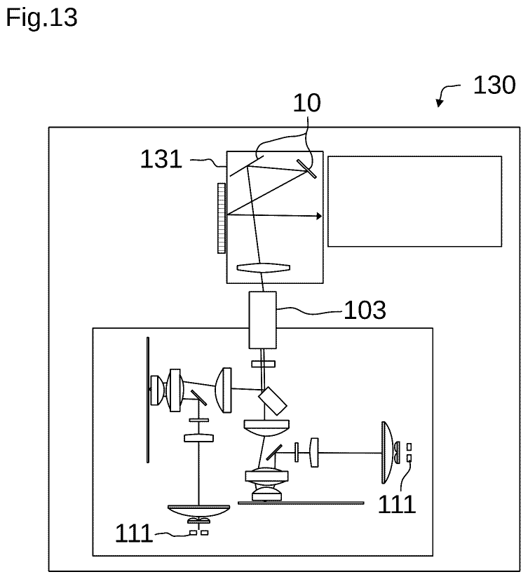

For example, FIG. 13 illustrates a light source device 130 including a light-source optical system 131 including meta-mirrors 10 and light sources 111 that emit light. The light source device 130 may have a light-source optical system including mirrors with power, and the meta-mirrors 10 may be used in place of such mirrors.

According to the above-described structure, by using the meta-mirrors 10 having a flat plate shape, space can be saved compared to when concave mirrors are used.

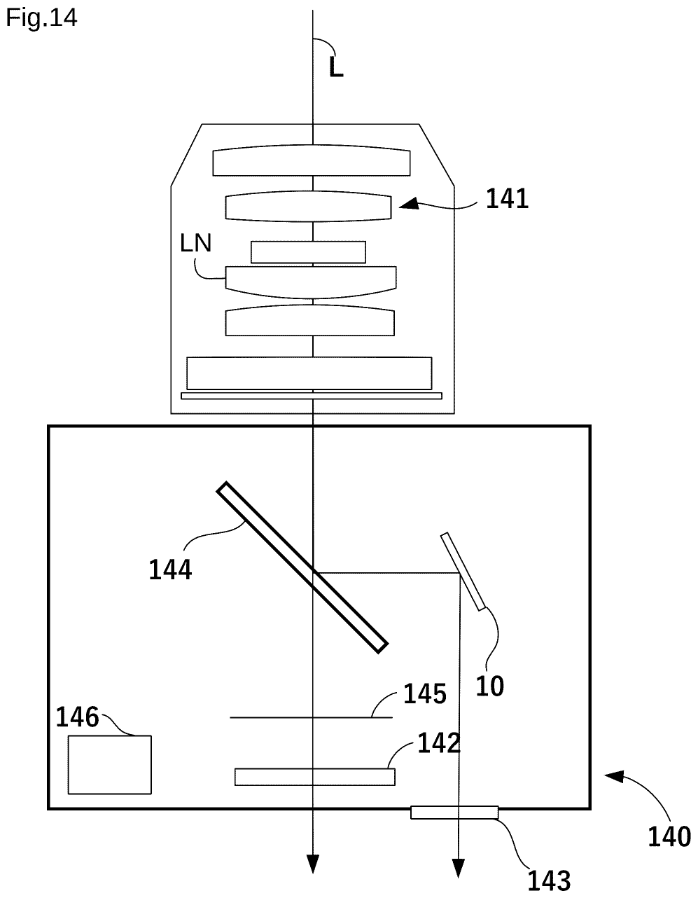

FIG. 14 illustrates a camera 140 that serves as an imaging device. The camera 140 includes a lens system 141 that serves as an imaging optical system for transmitting light from an object and causing the light to form an image on an imaging plane; a plurality of lenses LN included in the lens system 141; and an imaging element 142 that serves as a light receiving element for receiving the light that has reached the imaging plane.

The camera 140 also includes a finder 143 for checking the field of view, a meta-mirror 10 that deflects light from a mirror 144 toward the finder 143, a shutter 145 used to adjust an exposure time, and a control unit 146 for controlling these members.

The camera 140 is capable of capturing an image by causing light that has passed through the lens system 141 to be transmitted through the shutter 145 and form an image on the imaging element 142.

According to the related art, a prism or the like has been used to deflect light from the mirror 144 toward the finder 143. The meta-mirror 10 is capable of changing the direction in which the light rays are reflected in accordance with the filling factor. Therefore, by using the meta-mirror 10 having a flat plate shape, space can be saved compared to when the prism is used as a mirror.

In addition, space can be saved by using the meta-mirror 10 in place of a mirror with power or a combination of a flat mirror and a lens in a separating optical path between the imaging element 142 and the finder 143 in the camera 140.

In addition, in the optical system illustrated in FIG. 11, for example, the image display element 112 can be replaced by the imaging element 142 to convert the projecting system into an imaging optical system. Also in this case, space can be saved by using the meta-mirror 10 in place of a concave mirror.

A scanning optical system may also include an optical element, such as an Fθ mirror, or a combination of a flat mirror and a lens. Therefore, when the meta-mirror 10 according to the present invention is used in place of the FO mirror or the like, space can be saved also in the scanning optical system or an optical scanning device including the scanning optical system.

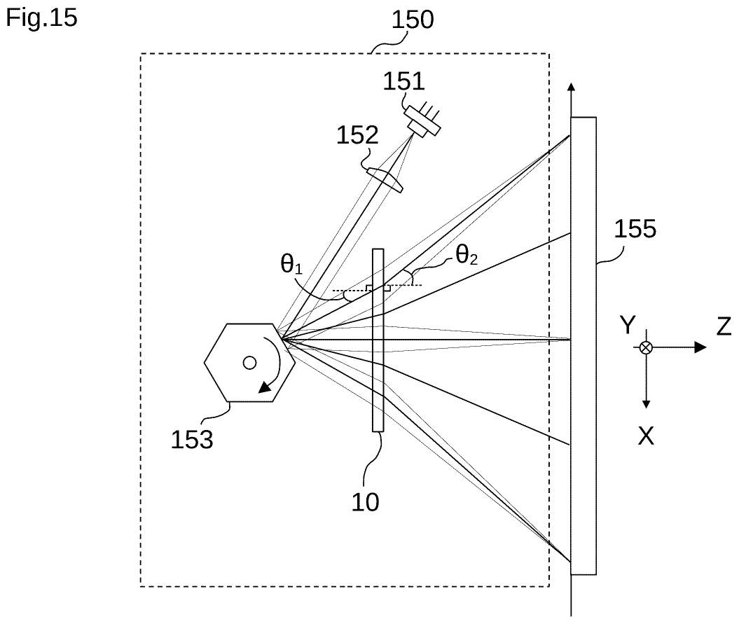

FIG. 15 illustrates an optical scanning device 150 according to an example including the meta-mirror 10 as an Fθ mirror.

The optical scanning device 150 includes a semiconductor laser 151 that serves as a light source, a coupling lens 152, and a polygon mirror 153 that serves as a deflector that converts incident light into scanning light by reflecting the incident light with a rotating mirror surface.

In the optical scanning device 150, the light beam emitted from the polygon mirror 153 is transmitted through the meta-mirror 10 and directed toward a photosensitive member 155, which is a scanning surface, so that the emitted light beam forms an image on the surface of the photosensitive member 155.

In this case, the photosensitive member 155 according to the present embodiment is a scanning surface irradiated with the scanning light emitted from the polygon mirror 153, and functions as an image formation plane.

The semiconductor laser 151 is a laser light source that oscillates light based on an image signal transmitted from another control unit, a reading unit of an image forming apparatus, or the like, and has a center wavelength of 780 nm in the present embodiment.

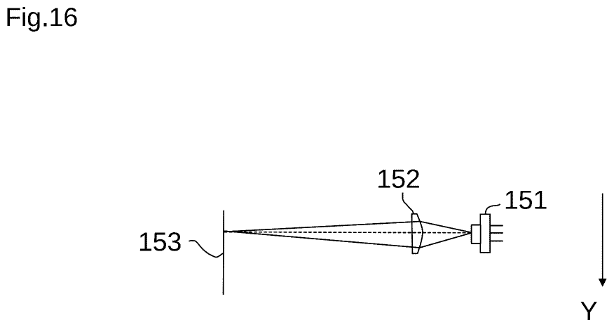

The coupling lens 152 is an optical element for collimating a divergent light beam incident on the coupling lens 152. The coupling lens 152 converts the incident light into light that is parallel in an X direction, or a main scanning direction, and that is focused on the surface of the polygon mirror 153 in a Y direction, or a sub-scanning direction, as illustrated in FIG. 16.

Light emitted from the semiconductor laser 151 and collimated by the coupling lens 152 is incident on the polygon mirror 153, so that the incident light is refracted at an angle that continuously changes in the main scanning direction, forming a beam spot with a diameter of about 70 μm on a scanned surface of the photosensitive member 155.

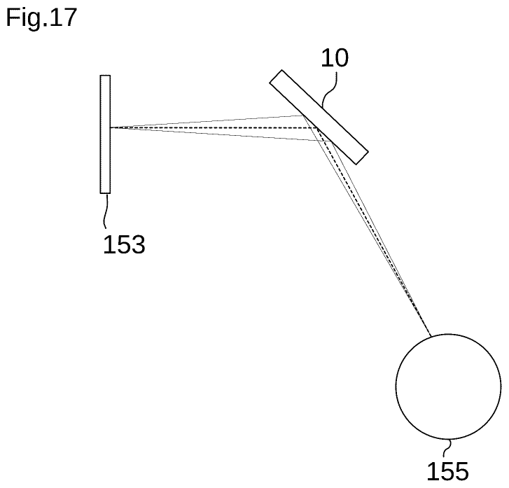

To schematically illustrate the optical path from the meta-mirror 10 to the surface of the photosensitive member 155, in FIG. 15, the emitted light is illustrated as if to pass through the meta-mirror 10 toward the photosensitive member 155. However, in practice, the light refracted by the meta-mirror 10 travels to the surface of the photosensitive member 155 as illustrated in FIG. 17.

As illustrated in FIG. 15, the polygon mirror 153 deflects the light such that the meta-mirror 10 receives off-axis light incident at incident angle θ₁ that varies relative to a perpendicular to the transmission surface 12.

Therefore, the distribution of the filling factor of the pillars 13 on the transmission surface 12 of the meta-mirror 10 from the axis to the periphery is designed in accordance with an incident height H of the light.

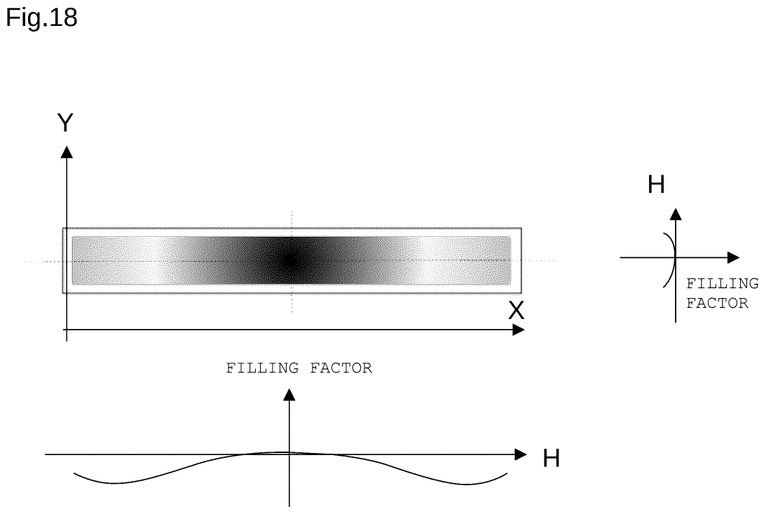

FIG. 18 illustrates the distribution of the filling factor by showing the density at each location in grayscale, with black representing the most dense areas and white representing the least dense areas. FIG. 18 also illustrates typical variations in the filling factor with respect to the incident height H of light in the X and Y directions around the optical axis in the respective cross sections. As is clear from FIG. 18, in the meta-mirror 10, the distribution of the filling factor of the pillars from the optical axis to the periphery is designed in accordance with the incident height H of light, and the unevenness of the distribution of the filling factor gradually varies in accordance with the incident height H for the off-axis light beam that is incident.

The above-described structure determines the focusing position and the emission direction of the off-axis light. An emission angle θ₂, which is a scanning angle, is determined so that an image height H at which the light reaches the image formation plane is proportional to the incident angle θ₁ determined by the deflection angle of the polygon mirror 153, that is, so that the scanning speed is constant.

FIG. 15 illustrates the emission angle θ₂ at which a light ray incident on the meta-mirror 10 at the incident angle θ₁ is emitted from the meta-mirror 10.

To scan the light over a wide field angle, the emission direction is preferably adjusted so that θ₂, which is the scanning angle of the off-axis light beam emitted from the meta-mirror 10, is greater than the incident angle θ₁ determined by the deflection angle of the polygon mirror 153. In other words, the emission direction is preferably adjusted so that θ₂/θ₁≥1 is satisfied.

In addition, in the present embodiment, as illustrated in FIG. 18, inflection points are present at intermediate locations in regions from the axis to the periphery in the main scanning direction.

By adjusting the filling factor of the pillars as described above, a positive refractive power for focusing the light on the scanning surface and a negative refractive power for increasing the field angle can both be obtained.

Since the distribution of the filling factor has inflection points Q, the meta-mirror 10 is structured such that the filling factor of the pillars 13 decreases from the axis toward the periphery along annular zones, and such that the positive refractive power increases toward the periphery in regions outside the inflection points.

According to such a structure, the distribution of the filling factor of the pillars 13 is adjusted so that the meta-mirror 10 has a field curvature that causes each light beam to be focused due to the positive refractive power, and with which the emission angle θ₂, which is the angle of the emission light, is greater than the incident angle θ₁.

According to the above-described structure, the emission angle θ₂ is greater than the incident angle θ₁, and the beam diameter is reduced. Thus, the positive refractive power for focusing the light on the scanning surface and the negative refractive power for increasing the field angle are both obtained.

In the above-described example, the single meta-mirror 10 includes a metasurface that is asymmetric about the optical axis such that the distribution of the filling factor from the optical axis toward the periphery varies differently between the main scanning direction and the sub-scanning direction. In other words, the meta-mirror 10 corresponds to a curved mirror having a toroidal surface with different curvatures in the main scanning direction and the sub-scanning direction. However, the meta-mirror 10 is not limited to this, and may have a metasurface that is symmetric about the optical axis.

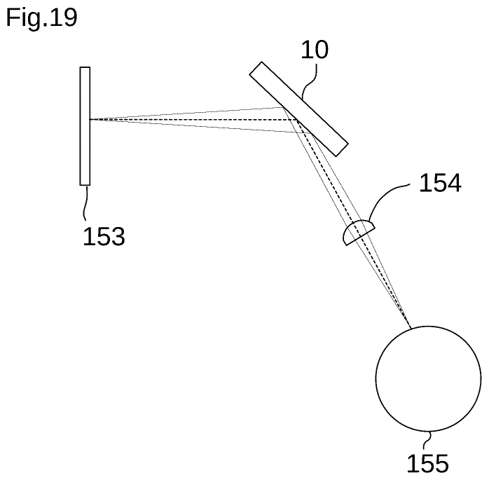

For example, as illustrated in FIG. 19, an elongated cylindrical lens 154 having a curvature in the sub-scanning direction may be additionally used. The elongated cylindrical lens 154 may be placed in the optical path between the meta-mirror 10 and the photosensitive member 155 to provide a function of correcting the surface tilt of the polygon mirror 153. In such a case, even when the meta-mirror 10 has a metasurface that is symmetric about the axis based on the design of the filling factor along the main scanning direction, since the focusing position in the sub-scanning direction is determined by the elongated cylindrical lens, the focusing position in the sub-scanning direction matches the focusing position in the main scanning direction.

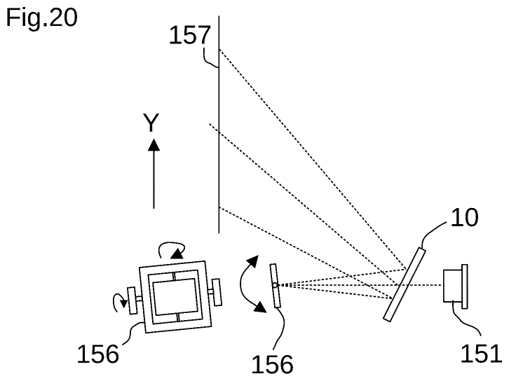

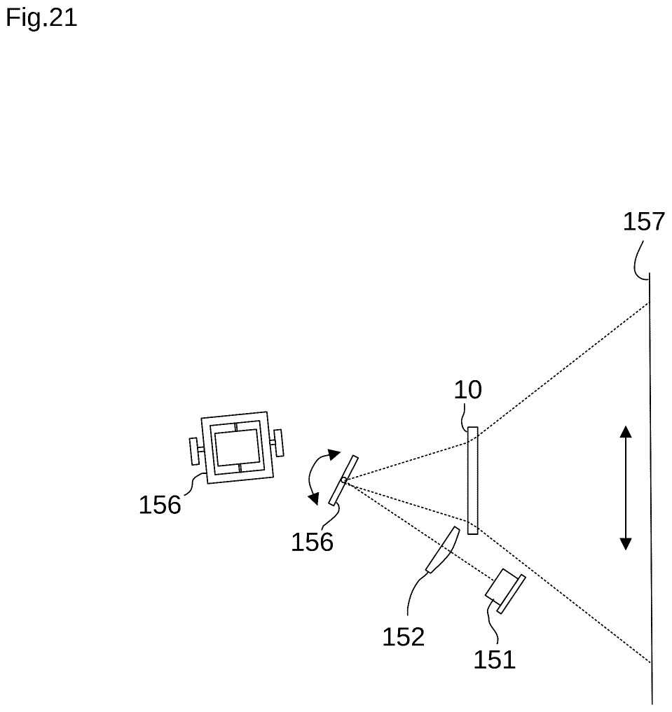

As illustrated in FIGS. 20 and 21, the optical scanning device 150 may include a two-dimensional deflection mirror 156 instead of the polygon mirror 153. The two-dimensional deflection mirror 156 has rotational axes that are orthogonal to each other.

When the two-dimensional deflection mirror 156 is used, a two-dimensional image can be projected onto a screen 157, which is a scanning surface, by scanning the light beam from the semiconductor laser 151 in a reciprocating manner along the main scanning direction and successively moving the scanning position in the sub-scanning direction.

When the two-dimensional deflection mirror 156 is used, focusing in the sub-scanning direction is not necessary. Therefore, the mirror surface can be more flexibly designed compared to when a polygon mirror is used.

For example, the above-described design of the filling factor in the region from the axis to the periphery for increasing the scanning angle θ₂ relative to the deflection angle θ₁ may be applied also to the sub-scanning direction. In such a case, the magnification of the off-axis light emitted from the meta-mirror 10 and forming an image on the scanning surface can be increased in both the main scanning direction and the sub-scanning direction.

In other words, according to such a structure, the optical scanning device 150 may be applied not only to a device for projecting light onto the screen 157 but also to a scanning magnifying projection device, such as a head-up display, a head-mounted display, or a portable projector.

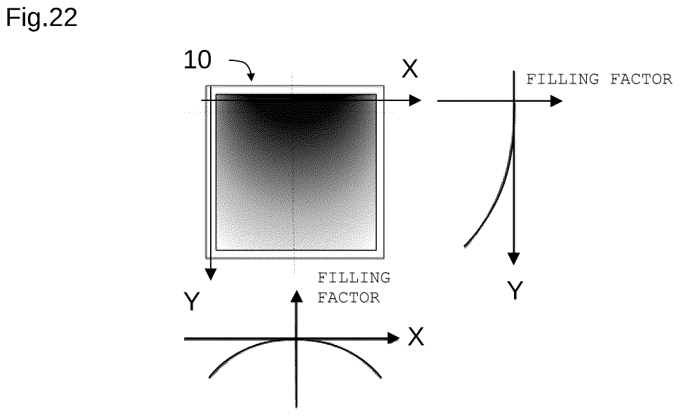

FIG. 22 illustrates an example of the distribution of the filling factor of the pillars from the axis to the periphery in the meta-mirror 10 included in a magnifying projection device.

Similarly to the example described with reference to FIG. 18 that corresponds to a toroidal surface having different curvatures in the main scanning direction and the sub-scanning direction, also in this example, the meta-mirror 10 is structured such that the distribution of the filling factor of the pillars from the axis to the periphery is designed in accordance with the incident height H.

More specifically, in order for the meta-mirror 10 to serve as a concave mirror having a positive refractive power and focus light on the screen 157, the filling factor is distributed such that the filling factor decreases from the optical axis toward the periphery, and designed such that the refractive power is lower for the off-axis light, which travels a longer distance to the image formation position, than for the on-axis light.

In addition, as described above, the emission direction can be adjusted to cause the light to reach a predetermined position on the screen 157 by designing the filling factor such that the unevenness of the distribution of the filling factor gradually varies in accordance with the incident height H of the off-axis light that is incident.

In other words, similarly to the above-described example, the unevenness of the distribution of the filling factor from the axis to the periphery can be adjusted to obtain both the positive refractive power for focusing the light on the screen 157 and the negative refractive power for increasing the field angle. Accordingly, an image can be magnified and projected onto the screen 157 over a wide field angle.

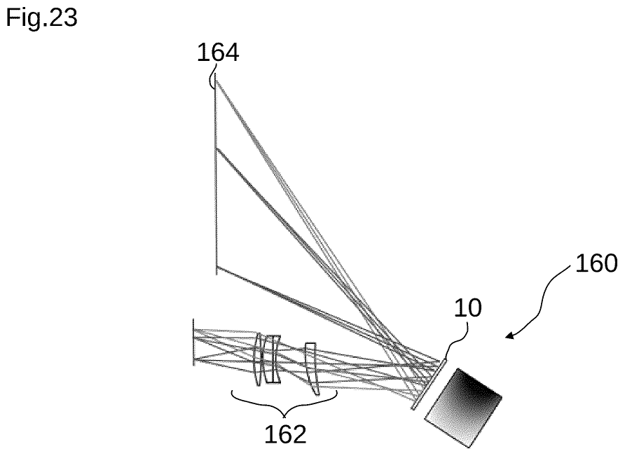

FIG. 23 illustrates a projector 160, which is an ultra-short throw image projection device. A projection optical system 162 included in the projector 160 often has an optical layout in which on-axis light and off-axis light cross in a region between the meta-mirror 10 and a screen surface 164.

In such a layout, as the distance to the position at which the on-axis light and the off-axis light cross decreases, the magnification on the screen surface 164 increases. Therefore, the unevenness of the distribution of the filling factor on the meta-mirror 10 is adjusted such that the on-axis light and the off-axis light cross at a close position. In this case, short throw projection is possible even when the distance between the screen surface 164 and the meta-mirror 10 is short.

Therefore, when the projection optical system 162 is provided with the meta-mirror 10, the filling factor may be designed to individually set the positive refractive power for focusing the light on the projection surface and the positive refractive power for increasing the field angle. Therefore, an effect similar to that obtained by a free-form curved surface formed on a concave mirror can be obtained by a flat surface. When such a flat surface is provided, the layout can be simplified, and the size can be greatly reduced.

In the structure illustrated in FIG. 23, light rays are caused to cross each other, as illustrated in FIG. 23, and the positive refractive power is set to increase the field angle and focus the light beam. However, this structure does not imply any limitation. For example, although not illustrated in the ray diagram of FIG. 23, a mirror surface to be reproduced by the meta-mirror 10 may be a convex mirror.

Embodiments of the present invention will now be described.
[1] A meta-mirror 10 according to the present invention is a single optical element including a transmission surface 12 that transmits light and on which a plurality of pillars 13 are continuously arranged, and a reflection surface 14. The pillars 13 is arranged with a density based on which a refractive index of the transmission surface 12 for the light is adjusted. The reflection surface 14 has a flat plate shape and reflects the light that has passed through the transmission surface 12. A dimension d of the pillars 13 in a horizontal direction relative to the transmission surface 12 and a wavelength λ of the light satisfy λ≥d, and the meta-mirror 10 causes the light deflected by the transmission surface 12 to be reflected by the reflection surface 14, so that the light is deflected in a direction different from an incident direction of the light.

According to the above-described structure, an optical element having a flat plate shape and having both refractive and reflective properties may be used to further reduce the size and weight of a folding mirror optical system.
[2] A meta-mirror 10 according to the present invention is the metasurface optical element according to [1], wherein the reflection surface 14 is formed on a surface facing the transmission surface 12.

According to this structure, light that passes through the transmission surface 12, which is a metasurface, is refracted, and then the light is reflected by the reflection surface 14. Thus, the meta-mirror 10 has an optical function similar to that of a concave mirror with power, and the space volume can be reduced.
[3] In addition to the structure according to [1] or [2], light incident on the transmission surface 12 in a direction perpendicular to the transmission surface 12 is deflected and emitted by the meta-mirror 10 in a direction different from the direction perpendicular to the transmission surface 12.

According to this structure, the direction in which the reflection surface 14 reflects light rays can be changed to any direction. This allows the meta-mirror 10 to be disposed vertically in the optical system for the incident light, so that the dead space can be further reduced to reduce the size and weight.
[4] A projection optical system including a meta-mirror 10 magnifies and projects an image displayed on a flat image display surface of an image display element 112 onto a single flat screen 119 as a projection image. The projection optical system includes a refracting optical system 113 and the meta-mirror 10 arranged in order from the image display surface toward the screen 119. The refracting optical system 113 includes a plurality of lenses LN. The meta-mirror 10 is a single optical element including a single reflection surface 14 that has a flat plate shape and a transmission surface 12 on which a plurality of pillars 13 are continuously arranged. The pillars 13 are arranged with a density based on which a refractive index of the transmission surface 12 for light is adjusted.

The projection optical system including the meta-mirror 10 causes an image-forming light beam emitted from the refracting optical system 113 to enter the meta-mirror 10 through the transmission surface 12, be reflected by the reflection surface 14, and be emitted through the transmission surface 12 to form the projection image on the screen 119.

According to the above-described structure, an optical element having a flat plate shape and having both refractive and reflective properties may be used to further reduce the size and weight of a folding mirror optical system.
[5] An image projection device 100 according to the present invention includes a meta-mirror 10 having the structure according to any one of [1] to [3] or [4], a light source 111, and an image display element 112.

According to the above-described structure, an optical element having a flat plate shape and having both refractive and reflective properties may be used to further reduce the size and weight of a folding mirror optical system.
[6] A light source device according to the present invention includes a light-source optical system 131 including a meta-mirror 10 having the structure according to any one of [1] to [3] or [4], and a light source 111 that emits light.

According to the above-described structure, an optical element having a flat plate shape and having both refractive and reflective properties may be used to further reduce the size and weight of a folding mirror optical system.
[7] A camera 140 that serves as an imaging device according to the present invention includes a meta-mirror 10 having the structure according to any one of [1] to [3] or [4].

According to this structure, the meta-mirror 10 enables a reduction in the thickness of an optical element included in the optical device, and space can be saved accordingly.
[8] An optical scanning device 150 according to the present invention includes a meta-mirror 10 having the structure according to any one of [1] to [3].

According to this structure, the meta-mirror 10 enables projection or scanning over a wider field angle, so that the aperture size of the meta-mirror 10 can be reduced. Thus, the number of meta-mirrors 10 that can be obtained from a single wafer can be increased, and the cost can be reduced.
[9] An optical scanning device 150 according to the present invention includes a meta-mirror 10 having the structure according to any one of [1] to [3], a light source 151, and a polygon mirror 153.

According to this structure, an optical element having a flat plate shape and having both refractive and reflective properties can used to provide a folding mirror having a function of a scanning optical system, so that the size and weight of the optical scanning device can be reduced.

Although preferred embodiments of the present invention have been described, the present invention is not limited to the specific embodiments, and various modifications and alterations are possible within the spirit of the present invention described in the claims unless specifically stated otherwise in the above description.

The effects described in the embodiments of the present invention are merely examples of the most preferable effects obtained by the present invention, and the effects of the present invention are not limited to those described in the embodiments of the present invention.

1. A metasurface optical element that is a single optical element comprising:
a metasurface including a transmission surface that transmits light and on which a plurality of nanostructures are continuously arranged, the nanostructures being arranged with a density based on which a refractive index of the metasurface for the light is adjusted; and
a mirror surface that has a flat plate shape and that reflects the light that has passed through the metasurface,
wherein a dimension d of the nanostructures in a horizontal direction relative to the transmission surface and a wavelength λ of the light satisfy λ≥d, and
wherein the optical element causes the light deflected by the metasurface to be reflected by the mirror surface so that the light is deflected in a direction different from an incident direction of the light.

2. The metasurface optical element according to claim 1, wherein the mirror surface is formed on a surface facing the metasurface.

3. The metasurface optical element according to claim 1, wherein light incident on the transmission surface in a direction perpendicular to the transmission surface is deflected and emitted in a direction different from the direction perpendicular to the transmission surface.

4. The metasurface optical element according to claim 1, wherein a distribution of the refractive index for the light is adjusted so that light incident on the transmission surface at an oblique incident angle relative to a direction perpendicular to the transmission surface is emitted from the metasurface at an angle different from the incident angle.

5. The metasurface optical element according to claim 4, wherein the distribution of the refractive index for the light is adjusted so that the light incident on the transmission surface at the oblique incident angle relative to the direction perpendicular to the transmission surface is emitted from the metasurface at an angle greater than the incident angle.

6. A projection optical system that magnifies and projects an image displayed on a flat image display surface of an image display element onto a single flat projection surface as a projection image, the projection optical system comprising:
a refracting optical system and a refracting-and-reflecting optical element arranged in order from the image display surface toward the projection surface,
wherein the refracting optical system includes a plurality of lenses,
wherein the refracting-and-reflecting optical element is a single optical element including a single mirror surface that has a flat plate shape and a metasurface including a transmission surface that transmits light and on which a plurality of nanostructures are continuously arranged, the nanostructures being arranged with a density based on which a refractive index of the metasurface for the light is adjusted, and
wherein the projection optical system causes an image-forming light beam emitted from the refracting optical system to enter the refracting-and-reflecting optical element through the metasurface, be reflected by the mirror surface, and be emitted through the metasurface to form the projection image on the projection surface.

7. An image projection device comprising:
the metasurface optical element according to Claim 1;
a light source; and
an image display element.

8. A light source device comprising:
a light-source optical system including the metasurface optical element according to Claim 1; and
a light source that emits the light.

9. An imaging device comprising:
an optical system including the metasurface optical element according to Claim 1.

10. An optical scanning device comprising:
an optical system including the metasurface optical element according to Claim 1.
